(19) United States
(12) Patent Application Publication
(10) Pub. No.: US 2015/0292263 A1
(43) Pub. Date: Oct. 15, 2015

(54) Supply Frame for a Tower; Tower with a Supply Frame and Method for Erecting a Supply Frame in the Interior of a Tower

(71) Applicant: MAX BÖGL WIND AG, Sengenthal (DE)

(72) Inventor: Martin Hierl, Neumarkt (DE)

(21) Appl. No.: 14/435,854

(22) PCT Filed: Oct. 15, 2013
(86) PCT No.: PCT/EP2013/071482

§ 371 Date: Apr. 15, 2015

(30) Foreign Application Priority Data
Oct. 16, 2012 (DE) 10 2012 109 860.3

(51) Int. Cl. E06C 1/39; E04H 12/00

(52) U.S. Cl. CPC E06C 1/39; E04H 12/00

(57) ABSTRACT

A supply frame for a tower, a wind turbine tower and related methods include use of annular or annular segment-shaped prefabricated concrete parts to support internal tower structures. Supply frame modules may form a self-supporting unit that can be attached in suspended fashion to an upper prefabricated concrete part of the tower. The supply frame may have a framework-like grid structure stabilized by traction forces from its own weight and live load.

The present invention refers to a supply frame for a tower, in particular a wind turbine tower made of annular or annular segment-shaped prefabricated concrete parts, which supports internal tower structures and can be arranged in the interior of the tower. Within the framework of this invention, internal tower structures are understood to be a lift arrangement (e.g. a lift cabin with lifting cables), cable arrangements that comprise power cables, supply cables and control cables, platforms for assembly and maintenance, ladders with ascending protection and lighting units. The supply frame extends essentially over the entire height of the tower and consists of several supply frame modules arranged on top of one another and attached to each other. The invention also refers to a tower made of prefabricated concrete parts in whose interior such a supply frame is arranged and a process for erecting a supply frame in the interior of a tower.

So the internal tower structures mentioned above can be arranged in the interior of a tower and be protected from environmental conditions, it is known from steel pipe sections to weld these components directly to the inner walls of the steel pipe sections. However, this causes a weakening of the corresponding steel pipe section so that the wall thickness has to be increased.

WO 03/067083 A1 has therefore suggested attaching such elements with magnetic force to the inner wall of the corresponding steel pipe section. However, such an embodiment is only possible with pure steel pipe towers and cannot be performed in current towers made of concrete.

DE 20 2010 007 565 U1 suggests erecting a wind turbine tower from several tubular tower sections whose ends have a flange with which they are attached to the tower section lying above. The internal tower structures such as a ladder element, cables, a lift and a platform, should be put together to a preassembled unit that is then built in the respective tower section to be hung there with the appropriate hooks on the flange of the tower section. In this case, the internal tower structures can, before assembling the respective tower section in them or after assembling the respective tower section, be lifted into position with a crane. This can make the erection of a wind turbine tower more difficult because preassembled internal tower structures can be in the way during the assembly or a difficult crane assembly of the internal tower structures is necessary. In addition, the stability of the internal tower structure can be limited owing to the individual attachment of the preassembled units.

DE 20 2011 106 727 U1 suggests a supply frame executed as support pipe for a wind power plant that consists of several pipe segments attached to one another by means of flanges, wherein the uppermost pipe segment is attached to the tower head with a claw and the lowest pipe segment is attached to the tower floor. The ascending ladder, the power cables and a supply shaft for control cables and light supply are attached to the support pipe. To assemble this, the first pipe segment must first be placed on the tower floor and attached to the inner wall of the tower by means of pressure supports and diagonal ties. Afterwards, several pipe segments are assembled on the first pipe segment and more pressure supports and diagonal ties are mounted to stabilize the supporting pipe. Owing to the embodiment of the supply frame as supporting pipe, the design options of the internal tower structures are limited.

The task of this invention is to suggest a supply frame for a wind turbine tower that can be manufactured easily and cheaply and is nonetheless very stable.

The task is solved with the characteristics of the disclosure herein.

A supply frame for a tower, particularly a wind turbine tower made of annular or annular segment-shaped prefabricated concrete parts supports inner structures, especially a ladder, a lift arrangement, particularly a lift cabin with hoisting ropes, cable arrangements, platforms and lighting units. The supply frame can be arranged in the interior of the tower and extends largely over the entire height of the tower. In this case, the supply frame is made up of several supply frame modules arranged on top of one another and attached to each other. A tower, particularly a wind turbine tower made of annular or annular segment-shaped prefabricated concrete parts has such a supply frame in its interior.

According to the invention, the supply frame has a framework-like grid structure that is preferably not kink-resistant under own weight and live load and can be attached in suspended fashion to an upper prefabricated concrete part of the tower. Here, the supply frame with the internal tower structures is merely stabilized by tension forces because of its own weight and the live load during operation, thus forming a self-supporting unit that ensures high stability during operation for all inner tower structures. Within the framework of this invention, “self-supporting” is understood to be a construction that, apart from its upper suspension, needs no additional stabilization through intermediate fastenings, lateral pressure supports or bracings, etc. Preferably, a grid structure that is actually is not kink-stable under own weight and live load is foreseen, which obtains its high stability only during the operation under own weight and live load. Through the narrow, not kink-stable design with suspended fastening, it is possible to manufacture the supply frame very economically with few materials. Due to the framework grid structure, the supply frame consists of simple and economical modular components such as corner posts, cross braces and diagonal trussing, which additionally allow easy handling while the supply frame is being erected. Thus, in a method for erecting a supply frame advantageously, the individual supply frame modules can also be assembled in the interior of the wind turbine tower from modular components and the supply frame modules with one another to obtain a self-supporting unit.

The supply frame modules are preferably executed equally with respect to one another. In particular, the top and lowest supply frame module can also be executed as special modules to facilitate attachment to an attachment device, for example.

According to an advantageous embodiment of the invention, at least one lift arrangement and one ladder (but preferably all internal tower structures) are arranged in an interior of the supply frame. As a result of this, all units are already arranged for protection inside the interior of the framework-like grid structure already while the supply frame is being assembled from the supply frame modules. Additionally, the compact arrangement in the interior of the supply frame facilitates the accessibility of the individual internal tower structures for the maintenance and assembly staff, while the tower's components (e.g. external spanners) are also easily accessible at the same time.

The lift arrangement and the ladder are advantageously positioned inside in such a way that the ladder can be accessed from a lift cabin at any time and at any height. As a result of this, the ladder advantageously constitutes a safe escape route over the entire height of the tower.

It is advantageous if at least one ladder module, one lighting unit, rope guides of the lift arrangement and cable attachments are pre-assembled on the various supply frame modules. This makes it possible to assemble the internal tower structures from the individual supply frame modules in an especially fast and easy way already outside the wind turbine tower and before the supply frame is built. At the same time, the one-piece assembly of the cables is facilitated by the cable attachments that have already been foreseen.

It is furthermore advantageous if the framework-like grid structure of the supply frame surrounds the interior completely and consists of an electrically conductive material. Because of this, unexpected electrical voltages can be derived from the concrete tower head to the foundation, passing through the grid structure.

It is therefore advantageous if the supply frame has a grounding installation or can be connected to a tower grounding installation. All internal tower structures are thus grounded via the supply frame.

It is furthermore advantageous if the height of a supply frame module corresponds to no more than the height of two prefabricated concrete parts, preferably to no more than the height of one prefabricated concrete part of the tower, because this facilitates the assembly of the individual supply frame modules inside the wind turbine tower,

In a tower with one supply frame, it is advantageous if the latter is suspended freely in the wind turbine tower and its base area is positioned in horizontal direction merely by a position safety device. So this can be achieved, the supply frame has a position safety device in its base area with which it can be positioned in horizontal direction. In this case, the position safety device serves merely to stabilize the oscillation and is not stressed during normal operation.

In a tower it is additionally advantageous if one of the tower's prefabricated concrete parts, particularly one of the top prefabricated concrete parts—which is preferably executed as spanner or transitional piece—for the suspended fastening of the supply frame made up of several supply frame modules. As a result of this, the supply frame extending over the entire height of the tower can be fastened as a whole to the top prefabricated concrete part in suspended fashion. However, it is also possible to attach the supply frame, for example, to the second- or third-highest prefabricated concrete part and to support one or two additional supply frame modules in the upper area of the supply frame on the suspended supply frame. A spanner or also a transitional piece of a hybrid tower is executed in a reinforced way and therefore especially suitable for fastening the supply frame and for absorbing such forces initiated by it.

According to an advantageous embodiment of the invention, the attachment device comprises several brackets attached to the prefabricated concrete part. It is particularly advantageous if the various brackets are screwed down with cast-in threaded bushes or bolts to the prefabricated concrete part. This makes an easy attachment to the supply frame to the prefabricated concrete part possible and at the same time manages to introduce substantial force into the prefabricated concrete part. To achieve this, the cast-in threaded bushes or bolts are attached to the appropriate reinforcements.

According to an advantageous further development, the attachment device comprises furthermore at least two struts that in each case join two brackets together and that as a result of that also make an attachment to different-sized supply frames and an attachment of the supply frame to various places inside the tower cross-section possible. Thereby the flexibility of a tower according to the invention is increased.

In a method for erecting a supply frame in the interior of a tower, it is especially advantageous if the supply frame made up of several supply frame modules is attached to a spanner, particularly to a transitional piece of the hybrid tower.

To erect a supply frame it is additionally advantageous if the tower is first built from the prefabricated concrete parts and finished and then the spanner or transitional piece is placed on top and the tower is braced with spanners. Finally, a preferably temporary hoisting device is supported on the spanner or transitional piece with which the supply frame is built in the tower. When doing so, a supply frame module is in each case attached from below to the supply frame module arranged on top. Since the supply frame is erected only after the tower is completed, all work that needs to be performed inside the tower, such as the laying down and bracing of the spanners, can continue without interruption. It is not necessary to use a crane standing outside of the tower for assembling the supply frame.

According to a first embodiment of the invention, a first supply frame module made up of several modular components and at least a part of the internal tower structure is assembled in the interior of the tower, lifted with the hoisting device to about the height of a supply frame module and then another supply frame module is assembled in the interior of the tower from the several modular components. Finally, the additional supply frame module is attached to the first supply frame module and the assembled supply frame modules are once again lifted to about the height of a supply frame module. In this process, it is advantageous that the supply frame modules can always be assembled in the same way from the numerous modular components in a fixed assembly location on the base of the tower and that the supply frame module can be attached always in the same position with the appropriate supply frame module arranged over it.

Additional supply frame modules are assembled analogously with the supply frame module arranged appropriately over them. After the lowest supply frame module is assembled, the entire supply frame is finally fastened in suspended fashion to the attachment device. It is therefore necessary for the assemblers to climb to the height of the attachment device merely to attach the supply frame to the attachment device.

According to a second embodiment of the invention, a first supply frame module made up of several modular components and at least one section of the internal tower structures is assembled in the interior of the wind turbine tower, lifted with the hoisting device to the top of prefabricated concrete part and attached in suspended fashion to the attachment device. The advantage of this is that the supply frame is from the very beginning attached to its subsequent built-in position on the attachment device and is assembled from top to bottom. The place directly above the tensioning basement ceiling of the tower remains freely accessible for the assembly of the individual supply frame modules from the corner posts, cross struts and diagonal stiffeners.

Afterwards, another supply frame module made up of several modular components and at least one part of the internal tower structures are assembled in the interior of the wind turbine tower, lifted with the hoisting device all the way to the lowest end of first supply frame module and assembled. Additional supply frame modules are assembled, lifted and mounted analogously and their upper end always joined together with the lower end of the supply frame module arranged above.

After assembly of the lowest supply frame module and after fastening the supply frame to the attachment device it is advantageous to arrange a position safety device in a foot area of the supply frame between the supply frame module and a foundation of the tower.

It is likewise advantageous if, only after the supply frame has been fastened to the attachment device, power cables and/or supply cables are pulled only individually and as a whole to the height of the attachment device and/or adapter or also lowered from top to bottom. As a result of this, the cables can be laid together and without adverse couplings. It is also alternately possible to also guide the cables upward with the gradually erected and lifted supply frame during the assembly of the tower according to the first embodiment.

It is furthermore advantageous if after completion of the tower at least one tubular steel segment is assembled on the tower, in which case one or several supply frame modules are pre-assembled in the steel segment and fastened to it. Here, the supply frame modules correspond to the supply frame modules in the tower or are at least compatible with them, so that a continuous frame is erected in the entire tower together with steel segments.

More advantages are described by means of the embodiments, which show:

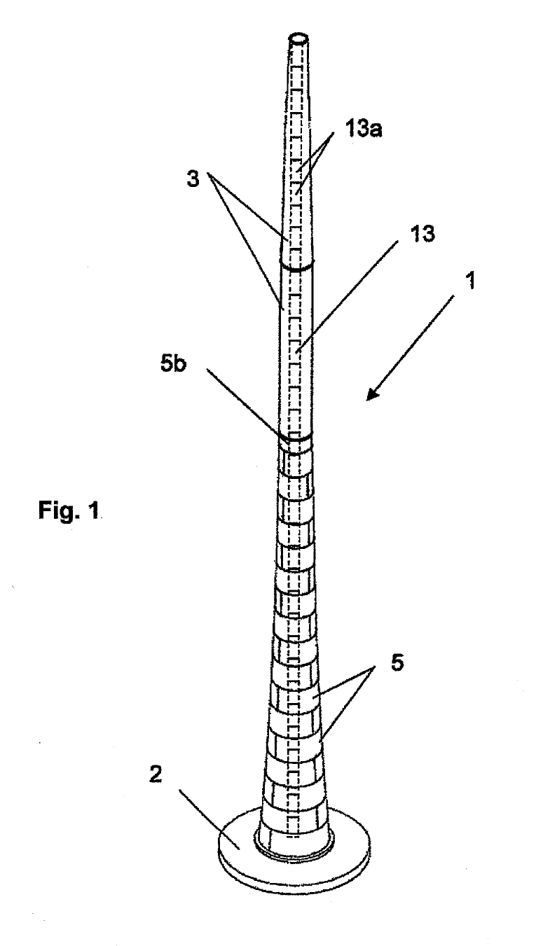

FIG. 1 a perspective outline view of a tower according to the invention,

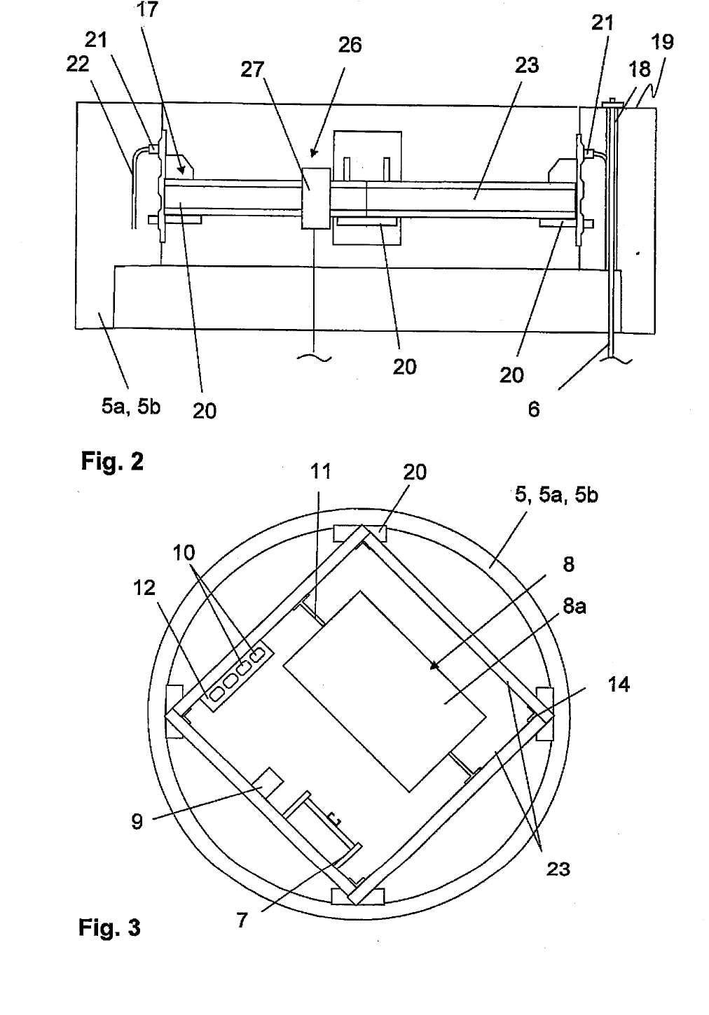

FIG. 2 a schematic section view of an attachment device for a supply frame,

FIG. 3 a top view of a supply frame according to the invention and the attachment device for fastening the supply frame,

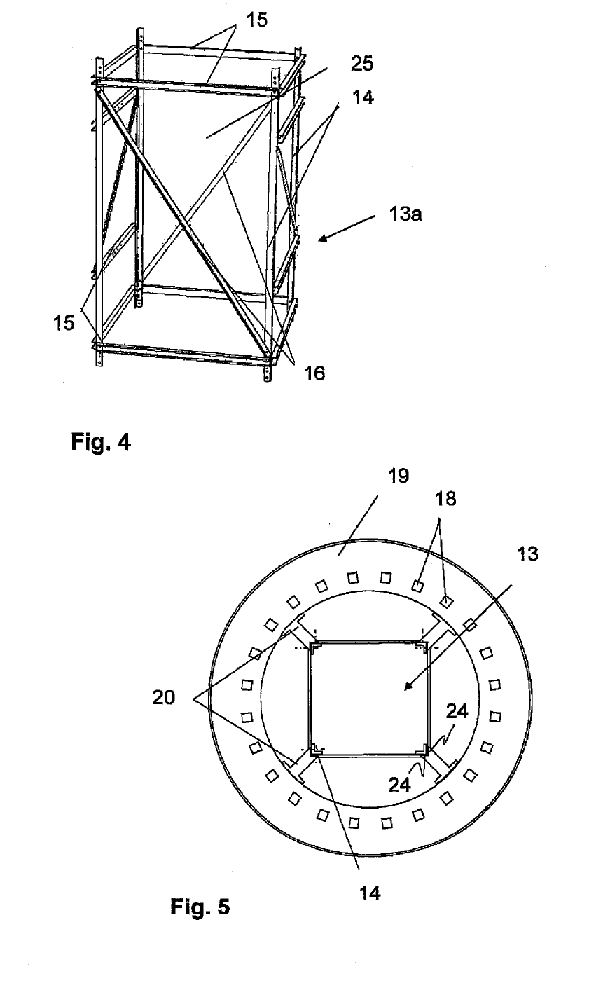

FIG. 4 a perspective view of a supply frame module of a supply frame,

FIG. 5 a top view of an attachment device for an alternative embodiment of a supply frame,

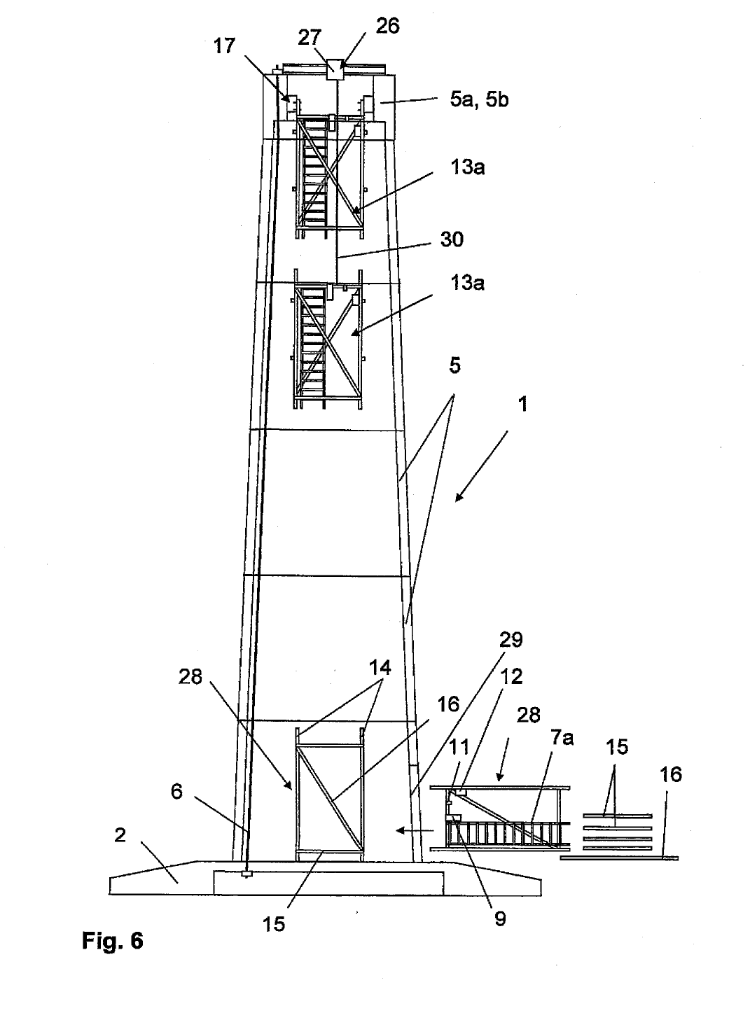

FIG. 6 a method for erecting a supply frame module by means of a schematic section view of a tower,

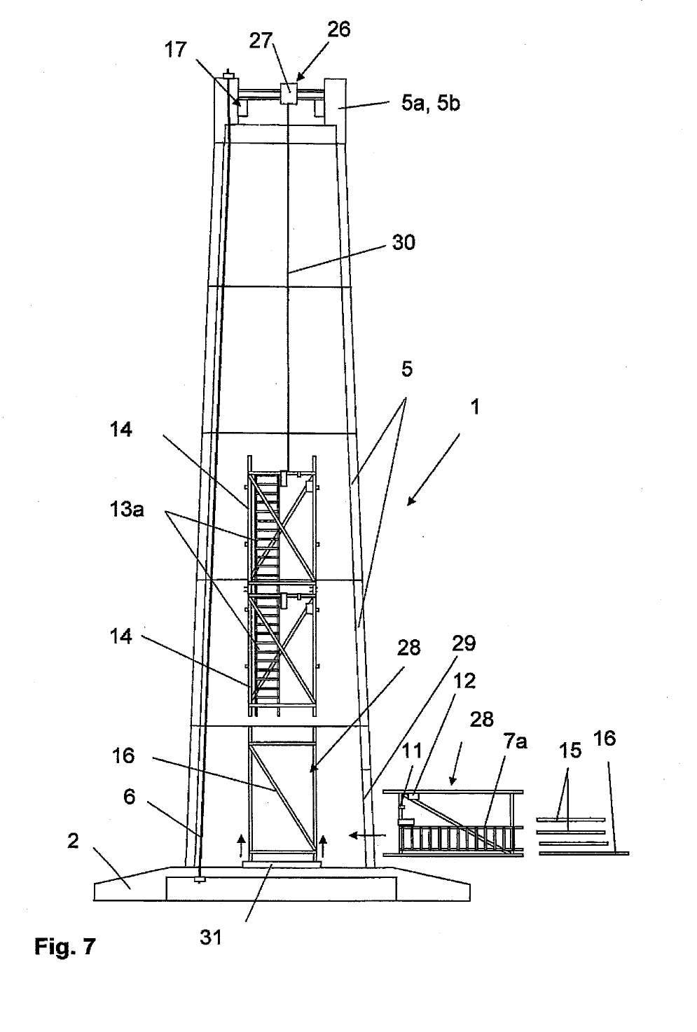

FIG. 7 an alternative method for erecting a supply frame,

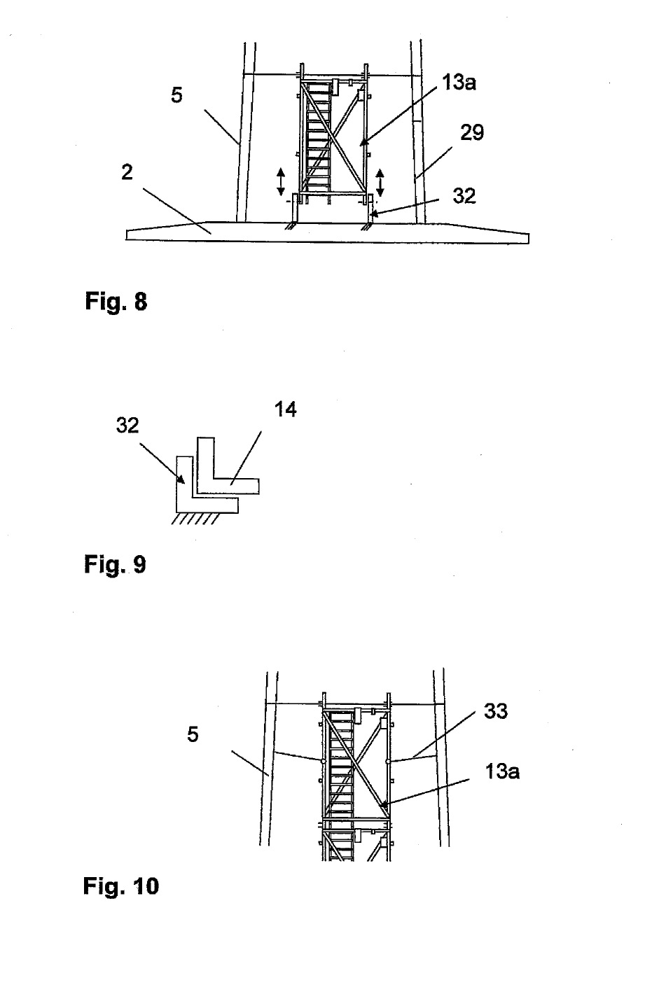

FIG. 8 a schematic section view of a position safety device for a supply frame according to the invention,

FIG. 9 a schematic top view of an alternative embodiment of a position safety device, and

FIG. 10 a detail of a schematic section view with spacers arranged on a supply frame.

FIG. 1 shows a perspective outline view of a tower 1 according to the invention, executed here as a wind turbine tower. The tower 1 consists of annular segment-shaped prefabricated concrete parts 5 that are in each case made up of concrete rings and are arranged on top of one another on a foundation 2 of the tower 1. According to this drawing, the tower is executed as hybrid tower which has additionally, above the prefabricated concrete parts 5, tubular steel segments 3 arranged on a transitional part 5b. In this case, the transitional part 5b serves both for connecting the steel segments 3 with the prefabricated concrete parts 5 and at the same time for fixing the spanners 6 in place (see FIG. 2) with which the prefabricated concrete parts are joined together and fastened to the foundation 2 and with which a pre-stress can be imposed on the tower section made of prefabricated concrete parts 5. The transitional piece 5b is also executed as prefabricated concrete part, but can also have a flange surface 19 (see FIG. 2) or a steel casing. In the interior of the tower 1, a supply frame 13 has been arranged for attaching the internal tower structures 7, 8, 9, 10, 11, 12 (see FIGS. 3, 6 and 7), shown here merely schematically in dotted representation.

The internal structures comprise components for the running operation as well as components for assembly and maintenance purposes. In a wind power turbine there are, for example, a ladder 7 formed by several ladder modules 7a, a lift arrangement 8 with a lift cabin 8a and hoisting and guiding ropes or also guiding rails, rope guides 11, lighting units 9 with all associated supply cables as well as various cable arrangements 10 with power cables, control cables and supply cables as well as cable clamping strips 12. Furthermore, assembly and maintenance platforms (not shown) can be provided. The internal tower structures 7, 8, 9, 10, 11 and 12 are recognizable in FIGS. 3, 6 and 7 and arranged in the interior 25 of the supply frame 13, from which only the corner posts 14 of one of the top supply frame module are visible.

The present invention now foresees the supply frame 13 to be made of several supply frame modules 13a (see FIG. 4), wherein the supply frame 13 made up of several supply frame modules 13a forms a self-supporting unit that can only be fastened to the tower 1 in a suspended way. Here, the entire supply frame 13 has been designed in such an easy and economical way that it is not kink-stable under own weight and live load. It gets its stability for the forces from the operation only because it is stressed by tensile forces due to its own weight and the live loads. In this case, the supply frame 13 or every single supply frame module 13a has a framework-like grid structure and consists of several simple modular components such as corner posts 14, cross struts 15 and diagonal stiffenings 16, which owing to their small dimensions can be easily handled and mounted together. The individual supply frame modules 13a are here firmly joined together, as the dotted lines between the two modular components 13a indicate in FIG. 7. Advantageously, the individual supply frame modules 13a are screwed down on the respective upper ends of their corner posts 14 with the respective lower ends of the corner posts of the supply frame modules 13a lying above. In this case, the supply frame modules 13a can be screwed down directly with one another or in each case by means of two connectors arranged between two supply frame modules 13a.

So that the supply frame 13 can be attached in a stable way to the tower 1, an attachments device 17 has been provided in one of the upper prefabricated concrete parts 5. According to the drawings shown in FIGS. 6 and 7, the entire supply frame 13 has been fastened to the top upper prefabricated concrete part 5 of the tower 1, which is a spanner 5a for anchoring the pre-stressing elements 6. If steel segments 3 are still arranged on the prefabricated concrete parts 5, the spanner 5a is executed as transitional part 5b that additionally makes the attachment of the steel segments 3 possible.

FIG. 2 shows a schematic section drawing of such a spanner 5a with an attachment device 17. The spanner 5a has numerous openings 18 distributed over its perimeter through which pre-stressing elements 6 can be inserted through in a known way and fixed in place on an upper flange surface 19 of the spanner 5a. According to the embodiment shown, the attachment device 17 comprises several brackets 20 distributed over the interior perimeter of the spanner. Here, the brackets 20 are screwed down with the spanner 5a in cast-in threaded bushes 21. In this case, the threaded bushes 21 can be joined together with reinforcements 22, so that the brackets 20 can be stably fastened to ensure the load transfer in the tower 1. Likewise, threaded bolts can be cast in instead of the threaded bushes 21 shown here. Here, the attachment device 17 is shown using the example of a spanner 5a, but a simple prefabricated concrete part 5 or a transitional part 5b can just as well be provided with such an attachment device. In such cast-in threaded bushes 21, it is advantageous that they can also be used for other purposes. Thus, by means of the cast-in threaded bushes 21 a prefabricated concrete part 5, 5a, 5b can be clamped on a holding device and processed during its manufacturing; for example, the front faces of the prefabricated concrete parts 5, 5a, 5b can be touch-sanded. It is likewise also possible before or after mounting the prefabricated concrete part 5, 5a, 5b to attach temporary assisting devices such as ladders to the threaded bushes 21.

FIG. 3 shows a top view of a prefabricated concrete part 5, 5a, 5b with an attachment device 17 arranged on it, as shown in FIG. 2. According to the embodiment sown, the attachment device 17 furthermore includes struts 23, here four struts 23 placed on top of the brackets 20. According to the present drawing, only the corner posts 14 (which are attached between two struts 23 in each case) of the supply frame 13 are visible. The attachments, especially threaded joints, are symbolized by dot-dashed lines. The advantage of this embodiment is that—owing to the attachment of the supply frame 13 to struts 23—supply frames 13 of various dimensions can be attached. Here, and deviating from the embodiment shown, it is also possible to superimpose merely two struts 23 parallel to one another on brackets 20, wherein the struts 23 connect in each case two brackets 20 to one another. Additional struts 23 can then be arranged transversally to the first struts 23 at any distance from each other and be connected to the first struts 23, also superimposed on the first struts 23, for example.

An alternate embodiment of an attachment device 17 is shown in a schematic top view in FIG. 5. Here, the attachment device 17 encompasses brackets 20, which have bearing surfaces 24 for a direct fastening of the corner posts 14 of the supply frame 13.

Furthermore, the placement of the internal tower structures 7, 8, 9, 10, 11, 12 on the supply frame 13 is recognizable in FIG. 3. Owing to the lean design of the supply frame 13 with regard to kink stability and the simple framework-like grid structure, it is possible to execute the supply frame 13 according to the invention with relatively large dimensions without increasing manufacturing costs unreasonably as a result of this. For this reason, the supply frame 13 has a relatively large interior that in particularly advantageous way allows the arrangement of all internal tower structures 7, 8, 9, 10, 11, 12 in the interior 25 by protecting them while making well accessible. Also, as a result of this, the additional components of the wind power plant arranged in the interior of the tower 1 and the pre-stressing elements are easily accessible too. The lift arrangement 8 and the ladder 7 are arranged in the interior 25 in such a way next to, or in front of, one another that the ladder 7 can be accessed from the lift cabin 8a at any time, thus providing an escape route over the entire height of the supply frame 13.

As can also be seen in FIG. 3 or also in FIG. 4, the framework-like grid structure of the supply frame 13 or of each supply frame module 13a encloses the interior 25 completely, thus providing a grounding simultaneously through the electrically conductive supply frame 13. The internal tower structures 7, 8, 9, 10, 11, 12 are at the same time grounded through it owing to the arrangement on the supply frame 13.

FIG. 6 shows a method for assembling the supply frame 13 in the interior of the tower 1. Here, the prefabricated concrete parts 5 are placed on the foundation 2 on top of one another until, after the desired structural height of the tower 1 is reached, the spanner 5a or a transitional part 5b is placed on the prefabricated concrete parts 5 arranged on top of one another. The attachment device 17, which contains brackets 20 for example, has in this case already been pre-assembled on the spanner 5a. Afterwards, the pre-stressing elements 6 are pulled in, fixed in place and braced in a known way, so that the tower 1 is now pres-stressed and therefore stands stably and is attached to the foundation 2. Using a crane (not shown) that is available anyway for assembling the prefabricated concrete parts 5 of the tower 1, a temporary hoisting device 26 can be supported on the top prefabricated concrete part 5, here the spanner 5a. In this case, as shown here, the hoisting device 26 can merely comprise a truss with a winch 27 or the hoisting device 26 can also have additional functions, such as a weather protection for the interior of the tower 1.

In this case, the truss of the hoisting device 26 has been placed on the top prefabricated concrete part 5 or the transitional part 5b or the spanner 5a. Likewise, a hoisting device 26 can also be attached to one of the struts 23 (see FIG. 3) that serve for fastening the supply frame 13 and/or the detail of a platform (not shown). The winch 27 can here also be fastened directly to one of the struts 23, as shown in FIG. 7. According to an embodiment not shown, the winch 27 can also be arranged in the foot area. In this case, the hoisting device 26 comprises a deflection roller, which is mounted on the brackets 15, on struts 23 or also on a separate truss.

After the temporary hoisting device 26 has been positioned in place, it is possible to start assembling the supply frame 13 from the individual supply frame modules 13a. According to the drawing shown here, individual side walls 28, which consist in each case of two corner posts 14, at least two cross struts 15 and, if need be, a diagonal stiffening 16 as well, have already been assembled outside of the tower 1. The pre-assembled side walls 28 and additional modular components 14, 15, 16 can be brought into the interior of the tower 1 through a relatively small opening 29 in the foot area of the tower 1 due to their still small dimensions. Depending on the size of the supply frame module 13a, it is nonetheless also possible to pre-assemble it completely outside of the tower 1 and to bring it in to the interior of the tower 1 through the opening 29 or to bring merely the modular components 14, 15, 16 and internal tower structures 7, 8, 9, 10, 11, 12 into the interior of the tower 1 and assemble all the supply frame modules 13a there. However, it is especially advantageous if at least individual side walls 28 are already pre-assembled because then at least one part of the internal tower structures 7, 8, 9, 10, 11, 12 can already be pre-assembled on them.

Here, a ladder module 7a, a lighting unit 9, rope guides 11 and cable clamping strips 12 have already been pre-assembled on individual modular components 14, 15, 16 or pre-assembled side walls 28. After the side walls 28 have been lifted into position and, if need be, additional modular components 14, 15, 16, the supply frame module 13a is put together on the floor of the foundation 2. Once the first supply frame module 13a has been put together, it is fastened to a rope 30 of the hoisting device 26 and lifted all the way to the height of the attachment device 17, where it is already mounted in its final position, fastening it with screws (dotted lines), for example. Afterwards or already during the lifting of the first supply frame module 13a, the side walls 28 and/or modular components 14, 15, 16 of the second supply frame module 13a is brought into the interior of the tower 1 and put together on the floor of the foundation 2. After the second supply frame module 13a is assembled, it is lifted, in turn, with the hoisting device 26 and its upper end is joined to the lower end of the first supply frame module 13a. The following supply frame modules 13a are put together on the floor of the foundation 2 in a similar manner, lifted in each case all the way to the height of the last assembled supply frame module 13a using the hoisting device 26 and joined to it. To assemble the supply frame modules 13a, the assemblers can drive upward with the supply frame modules 13a to be assembled and lower them once again with the hoisting device 26. To achieve this, the hoisting device 26 and/or the supply frame module 13a can have, for example, a temporary platform. Likewise, the assemblers cab remain also on the place of assembly, however, and as the frame module 13 is being built and becomes higher, reach the next assembly position from top to bottom using the ladder 7, which also becomes bigger towards the bottom.

According to an alternative method shown in FIG. 7, it can also be foreseen for the first supply frame module 13a to be lifted just to the height of a supply frame module 13a after assembly on the floor of the foundation 2 and remain suspended on the temporary hoisting device 26. Regarding the arrangement and attachment of the winch 27 of the hoisting device 26, the alternatives already described in FIG. 6 are, in turn, also conceivable. Afterwards, the following supply frame module 13a is, in turn, put together on the floor of the foundation 2 and joined its upper end to the lower end of the supply frame module 13a that is being held by the hoisting device 26. To facilitate the joining of the supply frame modules, a hoisting platform 31 can also be provided on the floor of the foundation 2 with which the supply frame module 13a to be assembled can be lifted to the height of the already assembled supply frame modules 13a. Additional supply frame modules 13a are put together analogously on the foundation floor or on the hoisting platform 31 and joined with the lower end of the supply frame module 13a arranged on top, in which case the supply frame modules 13a that have already been mounted are lifted gradually to the height of one supply frame module 13a with the hoisting device 26. After the lowest supply frame module 13a has been assembled, in which case if necessary a position safety device 32 (cf. FIG. 8) can already be assembled too (at least partially), the entire supply frame 13 is finally lifted with the hoisting device 26 exactly to the height of the attachment device 17 and fastened there.

The advantage of this embodiment is that all work can be performed in always the same manner on the floor of the foundation 2 until the supply frame 13 is completed and assemblers only need to be brought to fasten the entire supply frame 13 to the attachment device 17 to the height where the attachment device 17 is located. However, it is also possible within the framework of the invention to apply a mixture of the two erection methods described above.

If the supply frame 13 has been fastened to the attachment device 17 and the last supply frame module 13a mounted, the temporary hoisting device 25 can be taken down. The supply frame 13 is now freely suspended from the attachment device 17 and is positioned in its foot area in horizontal direction with respect to the tower 1 only with a position safety device 32, as shown in FIG. 8. In doing so, the position safety device can, as indicated by the dot-dashed lines in FIG. 8, include a vertically displaceable connection to the lowest supply frame module 13a or, as shown in FIG. 9, merely a corner post 14 of the lowest supply frame module 13a without encompassing a connection to it. As can be seen in FIG. 8, the supply frame 13 has been executed a little shorter than the tower 1, so that even if the tower 1 and the supply frame 13 have different longitudinal extensions, a pressure load and a buckling of the supply frame 13 cannot occur if the tower 1 starts rocking.

Depending on the height of the tower 1 and of the supply frame 13 it can furthermore be advantageous to position the supply frame 13 in horizontal direction with respect to the tower's inner wall with flexibly pivoted spacers 33, as shown schematically in FIG. 10. When doing so, flexibly pivoted spacers 33 are arranged in regular distances between the position safety device 32 in the foot area of the supply frame 13 and of the attachment device 17 in the head area of the supply frame 13, for example in distances of 20 meters each. Owing to the flexible pivoting of the spacers, a correct positioning of the supply frame 13 is still ensured, even after longitudinal direction displacements of the supply frame 13 with respect to the tower 1. Just like the position safety device 32 in the foot area, the spacers 33 serve merely to secure the position of the supply frame if strong winds or the rotor make it vibrate and they are not stressed during normal operation.

If the tower 1 is a hybrid tower of a wind power station, then the tower 1 is first built with the supply frame 13 (as described in FIG. 6 or 7) and a transitional piece 5b placed on top. After assembly of the supply frame 13, steel segments 3 (see FIG. 1) are then mounted on the transitional piece 5b. The steel segments 3 are provided likewise with supply frame modules 13a in their interior, which are at least compatible with the supply frame modules 13a of the concrete section. Preferably, the supply frame modules 13a have in this case already been pre-assembled in the steel segments 3 and fastened there to brackets 20 or flanges in a known way, for example by screwing or welding them together, by means of magnetic attachment or suspensions.

In the supply frame 13 and the method for erecting a supply frame 13, both according to the invention, it is advantageous for the internal tower structures 7, 8, 9, 11, 12 that they can already be pre-assembled on the supply frame modules 13a and, after the supply frame 13 has been mounted, that the cable arrangements 1 can be pulled individually or wholly upwards or can also be lowered continuously from the top. Likewise, owing to the mounting of the individual supply frame modules 13a with the hoisting device 26 and the already pre-assembled ladder modules 7a, the mounting can take place almost without any costly and time-consuming rope climbing work.

The invention is not restricted to the embodiments shown, Thus, according to the embodiments shown here, the height of a supply frame module 13a is by and large as high as the height of a prefabricated concrete part 5 or only slightly smaller. Furthermore, all supply frame modules 13a are shown as identical parts. To adjust to the spanner 5a or transitional piece 5b (which often have special dimensions) or to also reach a deviating foot element of a prefabricated concrete part 5, supply frame modules 13a of different heights and/or different structural shapes, but compatible with one another with regard to the attachment and the individual ladder modules 7a, can also be provided, however.

Additional variations and combinations also fall under the invention within the framework of the patent claims.

### LIST OF REFERENCE CHARACTERS

1 Tower
2 Foundation
3 Steel Segment
5 Prefabricated concrete part
5a Spanner
5b Transitional part
6 Pre-stressing element
7 Ladder
7a Ladder module
8 Lift arrangement
8a Lift cabin
9 Lighting unit
10 Cable arrangement
11 Rope guide
12 Cable clamping strip
13 Supply frame
13a Supply frame module
14 Corner post
15 Cross strut
16 Diagonal stiffening
17 Attachment device
18 Inner width
19 Flange surface
20 Bracket
21 Threaded bush
22 Reinforcement
23 Strut
24 Bearing surface
25 Interior
26 Hoisting device
27 Winch
28 Side wall
29 Opening
30 Rope
31 Hoisting platform
32 Position safety device
33 Spacer

1. A supply frame for a tower for a wind turbine and made of annular or annular segment-shaped prefabricated concrete parts, which supports internal tower structures including a ladder, a lift arrangement, cable arrangements, platforms and lighting units and that can be arranged in the interior of the tower and extends largely over the entire height of the tower, in which case the supply frame is made up of several supply frame modules arranged on top of one another and attached to each other, the supply frame comprising:
several supply frame modules forming a self-supporting unit that can be attached in suspended fashion to an upper prefabricated concrete part of the tower; and
the supply frame further having a framework-like grid structure stabilized by traction forces from its own weight and live load.

2. A supply frame according to claim 1, wherein the grid structure has no kink stability under its own weight and live load.

3. A supply frame according to claim 1, wherein at least one lift arrangement and one ladder, preferably all internal tower structures are arranged in an interior of the supply frame.

4. A supply frame according to, claim 3, wherein the lift arrangement and the ladder are positioned in such a way in the interior that the ladder can be accessed from a lift cabin of the lift arrangement.

5. A supply frame according to claim 1, wherein at least a ladder module of the ladder, a lighting unit, rope guides of the lift arrangement (8) and cable clamping strips are pre-assembled on the supply frame modules.

6. A supply frame according to claim 1, wherein the framework-like grid structure of the supply frame surrounds the interior completely.

7. A supply frame according to claim 1, wherein the supply frame has a grounding installation or can be connected to a grounding installation of the tower.

8. A supply frame according to claim 7, wherein the height of a supply frame module has at most the height of two prefabricated concrete parts of the tower, especially the height of one prefabricated concrete part.

9. A supply frame according to claim 8 wherein the supply frame has a position safety device in its foot area for positioning in horizontal direction with respect to the tower.

10. A tower for a wind turbine comprising:
annular or annular segment-shaped prefabricated concrete parts;
a supply frame arranged in the interior of the tower that extends largely over the entire height of the tower and supports internal tower structures, including a ladder, a lift arrangement, cable arrangements, platforms and lighting units and that is made up of several supply frame modules arranged on top of one another and attached to each other, the supply frame forming a self-supporting unit that can be attached in suspended fashion to an upper prefabricated concrete part of the tower; and
the supply frame further having a framework-like grid structure stabilized by traction forces from its own weight and live load.

11. A tower according to claim 10, wherein a prefabricated concrete part of the tower, has an attachment device for the suspending attachment of the supply frame made up of several supply frame models.

12. A tower according to claim 11, wherein the attachment device includes several brackets, which are attached to the prefabricated concrete part by threaded members screwed down to the concrete part.

13. A tower according to claim 10, wherein the attachment device includes at least two struts that join two brackets together.

14. A tower according to claim 9, wherein the supply frame suspends freely in the tower and is positioned in horizontal direction by a position safety device in its foot area.

15-23. (canceled)
